(19) United States
(12) Patent Application Publication
(10) Pub. No.: US 2016/0162371 A1
(43) Pub. Date: Jun. 9, 2016

(54) SUPPORTING MULTI-TENANCY THROUGH SERVICE CATALOG

(71) Applicant: NetApp, Inc., Sunnyvale, CA (US)

(72) Inventors: Vasantha Sadananda Prabhu, Bangalore (IN); Chaitanya Velpula, San Jose, CA (US); James Hartwell Holl, II, Los Gatos, CA (US); Jayanthi Babu Kolli, Fremont, CA (US); Vineet Abbi, Bangalore (IN)

(21) Appl. No.: 14/938,837

(22) Filed: Nov. 11, 2015

Related U.S. Application Data
(63) Continuation of application No. 12/985,198, filed on Jan. 5, 2011, now abandoned.

(51) Int. Cl. G06F 11/14

(52) U.S. Cl. CPC G06F 11/1461; G06F 2201/80

(57) ABSTRACT

The techniques introduced here provide for efficient creation and management of secure storage and backup in a cloud storage network. The techniques include a system and method for provisioning storage for a user in a cloud storage network. Using the techniques introduced here, a management module, upon receiving a request from a user for storage in a cloud storage system, determines a primary storage system and a secondary storage system for primary storage and backup storage, respectively, that meets the requirements of a service level selected by the user. The management module then creates and configures a primary virtual server and a secondary virtual server, for the primary storage and the backup storage, respectively, and provisions storage for the user. The techniques also include non-disruptive migration of data between virtual servers in response to a service level change.

### FIELD OF THE INVENTION

At least one embodiment of the present invention pertains to data storage allocation, provisioning, and protection, and more particularly, to data storage allocation, provisioning, and protection in a cloud environment.

### BACKGROUND

A storage controller is a physical processing device that is used to store and retrieve data on behalf of one or more hosts. A network storage controller can be configured (e.g., by hardware, software, firmware, or any combination thereof) to operate as a storage server that serves one or more clients on a network, to store and manage data in a set of mass storage devices, such as magnetic or optical storage-based disks, tapes, or flash memory. Some storage servers are designed to service file-level requests from hosts, as is commonly the case with file servers used in a network attached storage (NAS) environment.

Other storage servers are designed to service block-level requests from hosts, as with storage servers used in a storage area network (SAN) environment. Still other storage servers are capable of servicing both file-level requests and block-level requests, as is the case with certain storage servers made by NetApp®, Inc. of Sunnyvale, Calif., employing the Data ONTAP® storage operating system.

A cloud storage system can be defined as a collection of networked storage servers, for example, a data center, that makes storage available to clients over a network. A cloud storage system can be private, for example, accessible via a secure intranet, or public, for example, accessible via the Internet. In one implementation, cloud storage customers do not own the physical infrastructure; instead, they avoid capital expenditure by renting storage usage from a third-party provider. The customers may consume storage resources as a service and pay only for resources that they use. Sharing storage resources among multiple customers can improve storage system utilization, as individual storage servers are unnecessarily left idle less often.

With the increased use of cloud storage services, virtualized storage, and a large number of clients accessing data from these storage services, efficient and secure management of a cloud storage network is also becoming increasingly important to meet customer demands. Conventional cloud storage systems outsource backup of data stored on the cloud storage system to outside vendors. In such cases, the backup storage often is not securely stored, and an unauthorized user can access sensitive client data from the non-secure backup even if the primary cloud storage is secure.

Further, with conventional cloud storage technology that employs virtual storage servers, creation of each virtual storage server in a cloud storage network is handled individually. This is so even in cases where the same configuration is used for multiple virtual servers. Thus, scalability challenges arise in administering storage services in a large cloud storage network environment. For example, a large cloud can include thousands of virtual servers. Individually creating, provisioning storage for, and managing such a large number of virtual servers can be very time-consuming and burdensome.

### SUMMARY

The techniques introduced here provide for efficient creation and management of secure storage and backup in a cloud storage network, on a large scale, through the use of a service catalog. The service catalog is a data structure storing a collection of service levels provided on the cloud storage network. Users can request storage using the service catalog without a cloud administrator having to manually select a storage pool, create and configure a virtual storage server, and provision storage for each individual user. The techniques according to one embodiment include a system and method for provisioning storage for a user in a cloud storage network based on a request including a storage size and a service level. Using such techniques, a storage management module, upon receiving a request from a user for storage in a cloud storage system, automatically determines a primary storage system and a secondary storage system for primary storage and backup storage, respectively, that meet the requirements of the service level selected by the user, without requiring any involvement from the cloud administrator and without further knowledge of the cloud storage system by the user.

The management module then creates a primary virtual server and a secondary virtual server, for the primary storage and the backup storage, respectively, and provisions storage for the user. Thus, primary and backup storage are securely stored on individual virtual storage servers such that unauthorized users cannot access sensitive client data. Further, a cloud storage administrator needs only to set up a service catalog that includes the available service levels for users to choose from, instead of having to determine storage capacity and requirements from a user request and then provision each virtual storage server individually.

The techniques introduced here, in one embodiment, further include migrating data from an existing virtual storage server in a cloud storage network having a first service level to a newly created virtual storage server having a second service level, without disrupting an application that is accessing data on the existing virtual storage server. The migration of data to a new virtual storage server without disrupting client applications provides for more flexible scaling options to customers who have high availability requirements and does not require a cloud storage administrator to perform the migration, leaving time available to perform other important tasks.

Other aspects of the techniques summarized above will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements.

FIG. 1A shows an example of a network storage system including a network storage server.

FIG. 1B shows an example of a network storage system including virtual storage servers.

FIG. 2 is a diagram illustrating an example of a storage controller that can implement one or more network storage servers.

FIG. 3 schematically illustrates an example of the architecture of a storage operating system in a storage server.

FIG. 4 shows an example of a cloud storage system.

FIG. 5A shows an example of a service catalog.

FIG. 5B shows in more detail an example block diagram of a service level included in the service catalog of FIG. 5A.

FIG. 6 is a flow diagram of a process for provisioning storage for a user in a multi-tenancy environment.

FIG. 7 is a flow diagram of a process for migrating a virtual server in response to a change in service level.

### DETAILED DESCRIPTION

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

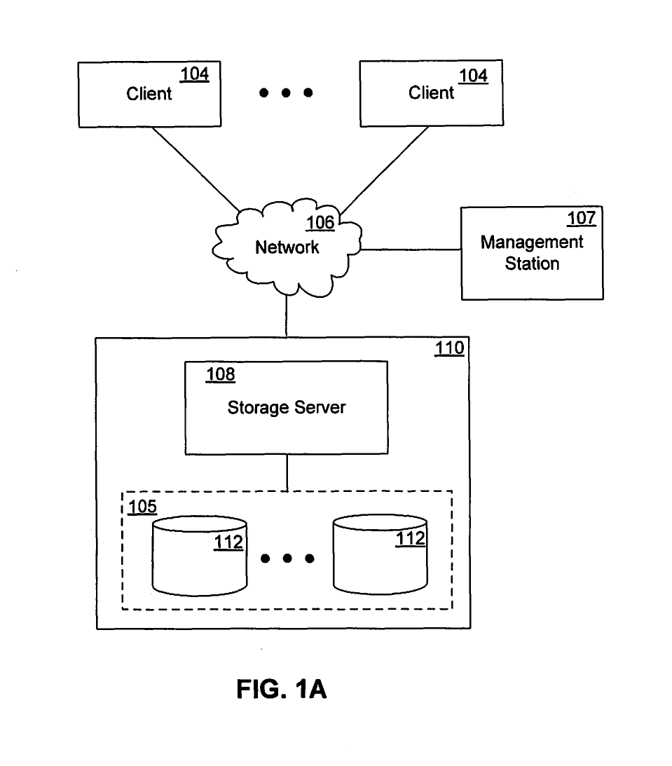

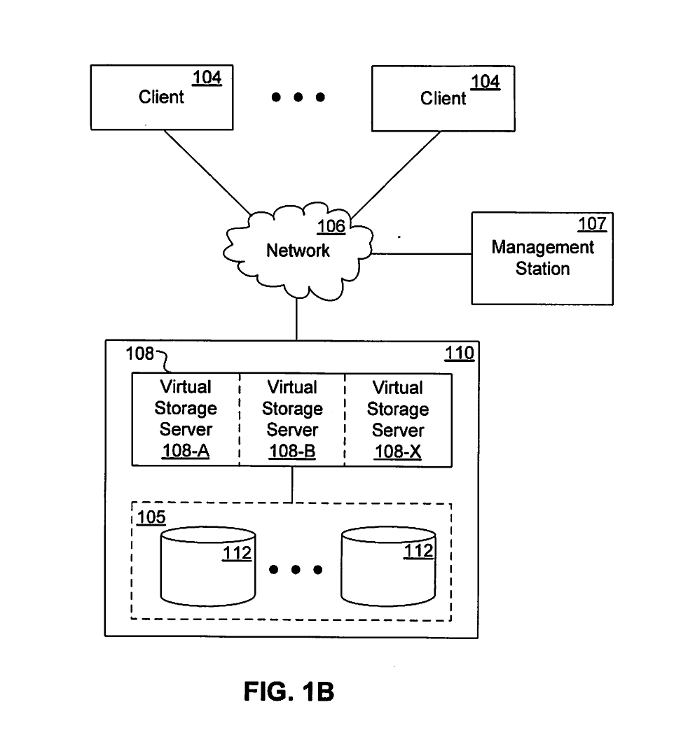

FIG. 1A shows an example of a network storage system, which includes a plurality of client systems 104, a storage system 110, and a network 106 connecting the client systems 104 and the storage system 110. As shown in FIG. 1, the storage system 110 includes a storage controller configured as a storage server 108, which is coupled to a number of mass storage devices 112, such as disks, in a mass storage subsystem 105. Alternatively, some or all of the mass storage devices 112 can be other types of storage, such as flash memory, solid-state drives (SSDs), tape storage, etc. However, to simplify description, the storage devices 112 are assumed to be disks herein.

The storage server 108 can be, for example, one of the FAS-series of storage server products available from NetApp®, Inc. The client systems 104 are connected to the storage server 108 via the network 106, which can be a packet-switched network, for example, a local area network (LAN) or a wide area network (WAN). Further, the storage server 108 can be connected to the disks 112 via a switching fabric (not shown), which can be a fiber distributed data interface (FDDI) network, for example. It is noted that, within the network data storage environment, any other suitable number of storage servers and/or mass storage devices, and/or any other suitable network technologies, may be employed.

The storage server 108 can make some or all of the storage space on the disk(s) 112 available to the client systems 104 in a conventional manner. For example, each of the disks 112 can actually be an individual disk, multiple disks (e.g., a RAID group) or any other suitable mass storage device(s). The storage server 108 can communicate with the client systems 104 according to any one or more well-known protocols, such as Network File System (NFS) or Common Internet File System (CIFS), to make data stored on the disks 112 available to users and/or application programs. The storage server 108 can present or export data stored on the disks 112 as storage objects, for example, volumes, to each of the client systems 104. Various functions and configuration settings of the storage server 108 can be controlled by a user, e.g., a storage administrator, from a management station 107 coupled to the network 106.

Although the storage controller 108 is illustrated as a single unit in FIG. 1A, it can have a distributed architecture. For example, the storage controller 108 can be designed as a physically separate network module (e.g., “N-blade”) and disk module (e.g., “D-blade) (not shown), which communicate with each other over a physical interconnect. Such an architecture allows convenient scaling, such as by deploying two or more N-blades and D-blades, all capable of communicating with each other through the interconnect.

In one embodiment, a storage controller 108 can be configured to implement one or more virtual storage servers as shown in FIG. 1B. Virtual storage servers allow the sharing of the underlying physical storage controller resources, e.g. processors and memory, between virtual storage servers while allowing each virtual storage server to run its own operating system (thereby providing functional isolation). With this configuration, multiple server operating systems that previously ran on individual machines, (e.g., to avoid interference) are able to run on the same physical machine because of the functional isolation provided by a virtual storage server implementation. This can be a more cost effective way of providing storage server solutions to multiple customers than providing separate physical server resources for each customer. Multi-tenancy can be defined as a virtual storage server arrangement similar to the one described above.

In the example of FIG. 1B, the storage controller 118 includes virtual storage servers 108-A, 108-B, and 108-X. As described above, the virtual storage servers share physical resources of the storage controller 118 while each virtual storage server runs its own operating system. Each virtual storage server manages one or more logical units of data in the mass storage subsystem 105. A logical unit can be any form of logical container of data, for example, a data block, a file, a directory, or a volume. Additionally, each virtual storage server can be considered an independent storage node.

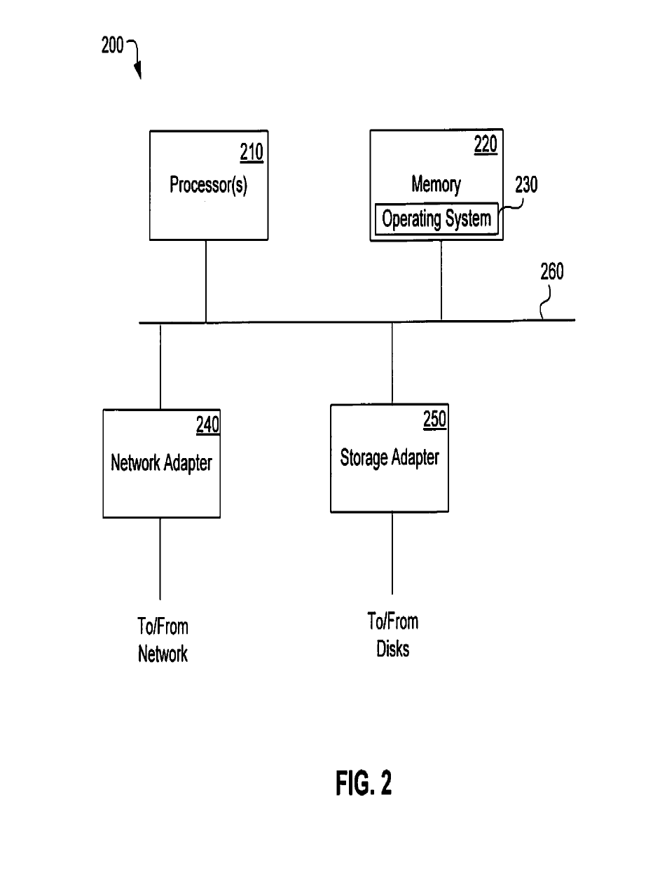

FIG. 2 is a diagram illustrating an example of a storage controller 200 that can implement one or more network storage servers 108, or virtual storage servers 108-A, 108-B, and 108-X. In an illustrative embodiment, the storage controller 200 includes a processor subsystem 210 that includes one or more processors. The storage controller 200 further includes memory 220, a network adapter 240, and a storage adapter 250, all interconnected by an interconnect 260.

The storage controller 200 can be embodied as a single- or multi-processor processing system. The processor(s) execute a storage operating system 230 that preferably implements a high-level module, called a storage manager, to logically organize data as a hierarchical structure of named units of storage, such as directories and files, on the disks 112.

The memory 220 illustratively comprises storage locations that are addressable by the processor(s) 210 and adapters 240 and 250 for storing software program code and data associated with the techniques introduced here. The processor 210 and adapters 240 and 250 may, in turn, comprise processing elements and/or logic circuitry configured to execute the software code and manipulate the data structures. The storage operating system 230, portions of which are typically resident in memory and executed by the processing elements, functionally organizes the storage controller 200 by (among other things) invoking storage operations in support of the storage service provided by the storage server 108. It will be apparent to those skilled in the art that other processing and memory implementations, including various computer readable storage media, may be used for storing and executing program instructions pertaining to the techniques introduced here.

The network adapter 240 includes a plurality of ports to couple the storage controller 200 with one or more clients 104, or other storage controllers, over point-to-point links, wide area networks, virtual private networks implemented over a public network (Internet) or a shared local area network. The network adapter 240 thus can include the mechanical components and electrical circuitry needed to connect the storage controller 200 to the network 106. Illustratively, the network 106 can be embodied as an Ethernet network or a Fibre Channel (FC) network. Each client 104 can communicate with the storage server over the network 106 by exchanging packets or frames of data according to pre-defined protocols, such as TCP/IP.

The storage adapter 250 cooperates with the storage operating system 230 to access information requested by the clients 104. The information may be stored on any type of attached array of writable storage media, such as magnetic disk or tape, optical disk (e.g., CD-ROM or DVD), flash memory, solid-state drive (SSD), electronic random access memory (RAM), micro-electro mechanical and/or any other similar media adapted to store information, including data and parity information. However, as illustratively described herein, the information is stored on disks 112. The storage adapter 250 includes a plurality of ports having input/output (I/O) interface circuitry that couples with the disks over an I/O interconnect arrangement, such as a conventional high-performance, Fibre Channel (FC) link topology.

Storage of information on disks 112 can be implemented as one or more storage volumes that include a collection of physical storage disks cooperating to define an overall logical arrangement of volume block number (VBN) space on the volume(s). The disks 112 can be organized as a RAID group. One or more RAID groups together form an aggregate. An aggregate can contain one or more volumes.

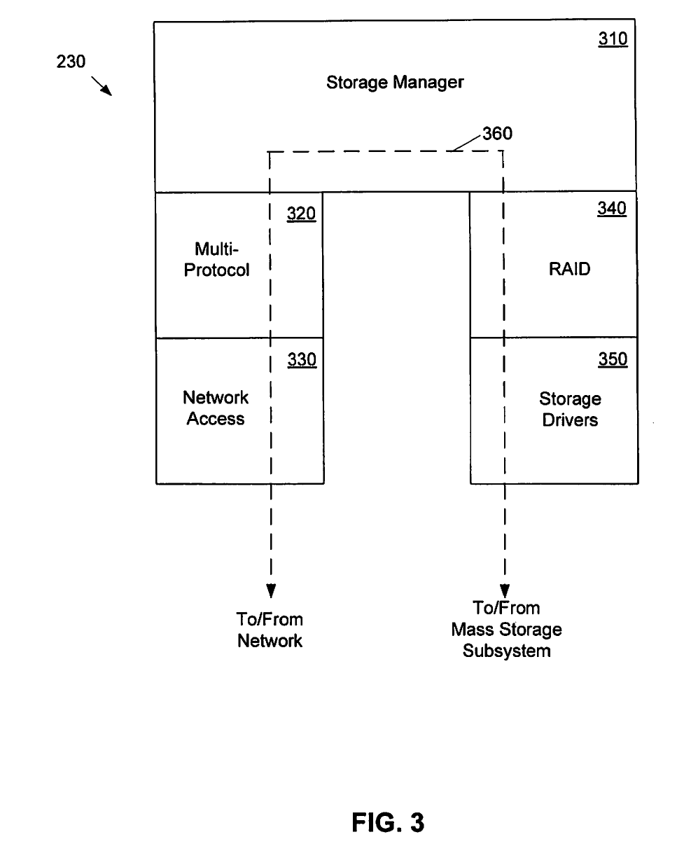

The storage operating system 230 facilitates clients' access to data stored on the disks 112. In certain embodiments, the storage operating system 230 implements a write-anywhere file system that cooperates with one or more virtualization modules to “virtualize” the storage space provided by disks 112. In certain embodiments, a storage manager 310 (FIG. 3) element of the storage operation system 230 logically organizes the information as a hierarchical structure of named directories and files on the disks 112. Each “on-disk” file may be implemented as a set of disk blocks configured to store information. The virtualization module(s) may allow the storage manager 310 to further logically organize information as a hierarchical structure of blocks on the disks that are exported as named logical unit numbers (LUNs).

FIG. 3 schematically illustrates an example of the architecture of a storage operating system 230, which can be implemented as part of a physical storage or virtual storage server. The storage operating system 230 can be implemented in programmable circuitry programmed with software and/or firmware, or in specially designed non-programmable circuitry (i.e., hardware), or in a combination thereof In the illustrated embodiment, the storage operating system 230 includes several modules, or layers. These layers include a storage manager 310, which is the core functional element of the storage operating system 230. The storage manager 310 imposes a structure (e.g., one or more file systems) on the data managed by the storage server 108 and services read and write requests from clients 104.

To allow the storage server to communicate over the network 106 (e.g., with clients 104), the storage operating system 230 also includes a multi-protocol layer 320 and a network access layer 330, logically under the storage manager 310. The multi-protocol layer 320 implements various higher-level network protocols, such as NFS, CIFS, Hypertext Transfer Protocol (HTTP), Internet small computer system interface (iSCSI), and/or one or more known backup/mirroring protocols. The network access layer 330 includes one or more network drivers that implement one or more lower-level protocols to communicate over the network, such as Ethernet, Internet Protocol (IP), Transport Control Protocol/Internet Protocol (TCP/IP), Fibre Channel Protocol (FCP) and/or User Datagram Protocol/Internet Protocol (UDP/IP).

Also, to allow the device to communicate with a storage subsystem (e.g., storage subsystem 105), the storage operating system 230 includes a storage access layer 340 and an associated storage driver layer 350 logically under the storage manager 310. The storage access layer 340 implements a higher-level storage redundancy algorithm, such as RAID-4, RAID-5 or RAID-DP™. The storage driver layer 350 implements a lower-level storage device access protocol, such as Fibre Channel Protocol (FCP) or small computer system interface (SCSI).

Also shown in FIG. 3 is the path 360 of data flow through the storage operating system 230, associated with a read or write operation, from the client interface to the storage interface. Thus, the storage manager 310 accesses the storage subsystem 105 through the storage access layer 340 and the storage driver layer 350.

The storage operating system 230 can have a distributed architecture. For example, the protocol layer 320 and network access layer 330 can be contained in an N-module (e.g., N-blade) while the storage manager 310, storage access layer 340 and storage driver layer 350 are contained in a separate D-module (e.g., D-blade). In such cases, the N-module and D-module (not shown) communicate with each other (and, possibly, with other N- and D-modules) through some form of physical interconnect and collectively form a storage server node. Such a storage server node may be connected with one or more other storage server nodes to form a highly scalable storage server cluster.

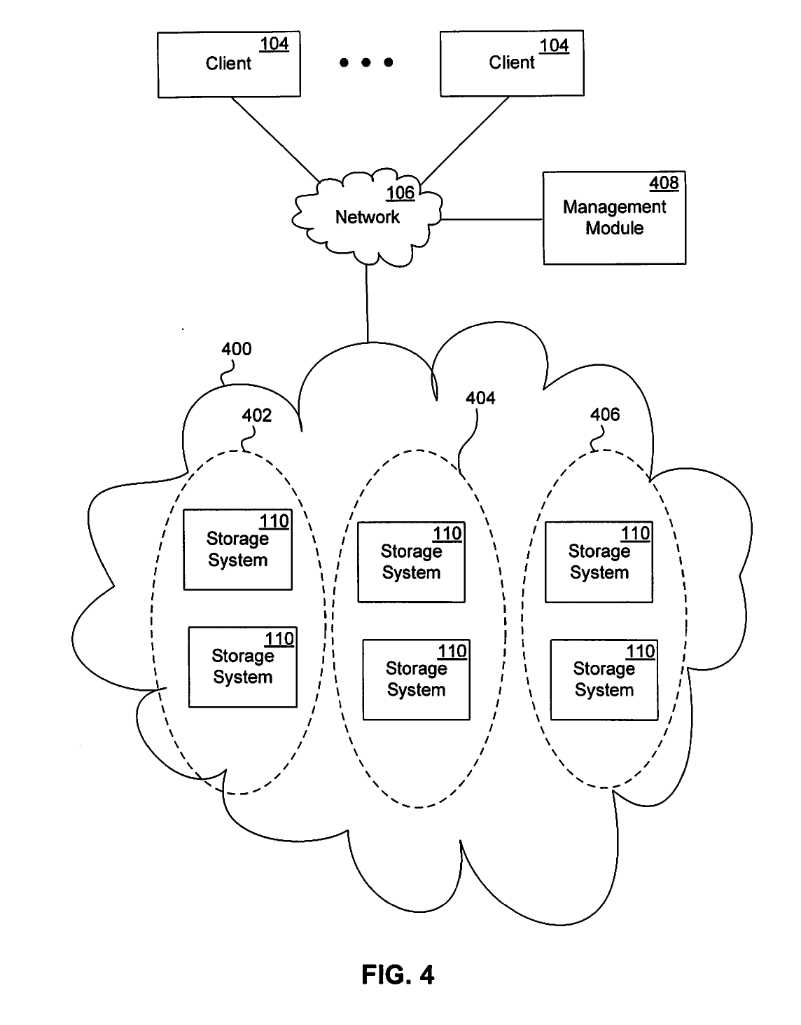

FIG. 4 shows an example of a cloud storage system 400. A cloud storage system can be defined as a network of shared resources that are available to clients over a network. In one embodiment, cloud storage customers do not own the physical infrastructure; instead customers avoid capital expenditure by renting usage from a third-party provider. The customers may consume resources as a service and pay only for resources that they use. Sharing resources among multiple tenants can improve utilization rates, as servers are not unnecessarily left idle.

In one embodiment, the cloud storage system 400 includes a plurality of storage systems 110. The storage systems 110 are connected by an interconnect (not shown). In the example of FIG. 4 clients 104 access the cloud storage system 400 through network 106. The cloud storage system 400 includes a front end server (not shown) that receives storage service requests and forwards the requests to an appropriate storage system 110 where the requests are serviced. The storage systems 110 can be classified into a number or resource pools, 402, 404, and 406 as shown in FIG. 4. A resource pool is a collection of storage systems having similar characteristics that can be managed as a single pool.

Traditionally, when a customer requests storage from the cloud storage system 400 a cloud storage administrator would allocate storage resources, for example, volumes, for the customer. As used herein, a dataset is a collection of storage resources associated with a customer plus all replications of those storage resources. The collection of storage resources in a dataset are managed by the same set of policies. For example, the cloud storage administrator could assign a single protection policy to all of the storage resources in a particular dataset. The protection policy could include, for example, schedules for creating backups, mirror copies, data transfer controls, backup retention controls, and disaster recovery controls. The protection policy can define primary, secondary, and tertiary storage nodes to use as primary, backup, and mirror locations, respectively.

Once a dataset has been assigned a protection policy, the cloud storage administrator would then have to assign a provisioning policy to each storage node defined by the protection policy. For example, the primary node, the secondary node, and the tertiary node can each be assigned a unique provisioning policy. The provisioning policy can include, for example, SAN/NAS provisioning specifications, deduplication settings, space utilization thresholds, access protocol information, multi-tenancy access protocols, and storage protection level (e.g., RAID level).

Further, the storage administrator would assign a resource pool to a storage node defined by the protection policy, for example, the primary node for primary storage, the secondary node for backup storage, and the tertiary node for mirroring, that meets the requirements set by the provisioning policy and that has available storage capacity to meet the customer request. In one embodiment, a storage node can be assigned more than one resource pool. Each resource pool conforms to a service level objective (SLO) defined by the service provider. For example, resource pool 404 may include storage systems 110 that provide the highest performance, lowest latency, and highest availability of the storage systems 110 in the cloud storage network 400. In contrast, resource pool 406 may include storage systems 110 that have lower performance and latency but are available to customers at a lower cost than resources from pool 404. Storage systems 110 in resource pool 402 may fall somewhere in between the high performance systems of resource pool 406 and the lower performance systems of resource pool 406. Finally, the storage can be provisioned and attached to a virtual server such that the customer can begin to access the storage.

In a typical cloud storage system, there is a common set of protection policies and provisioning policies that are assigned to different datasets in the cloud storage system based on service level objectives (SLOs) defined by the service provider. Instead of setting up each dataset with a protection policy and provisioning policies for each storage node defined by the protection policy, a single storage service which defines a set of protection and provisioning policies can be used. A storage service defines a level of service to be applied to storage resources in a dataset and includes a combination of a protection policy, a provisioning policy, and a resource pool. In one embodiment, a storage service includes a template used by a management module 408 to create a virtual server associated with a particular service level. A service provider can define a portfolio of storage services and provide customers a service catalog from which to select storage services. The service catalog can be stored as a data structure that is managed by management module 408.

The service catalog allows a user to pick a level of service that meets the needs of the applications that using the storage. For example, a user that is operating a small startup company with few client applications may not require the highest performance system, while a larger company that has more clients and applications accessing the storage may require higher performance. Further, each service level has an associated cost with lower performance services being less expensive. This variation in cost can play a role in what service level a customer ultimately chooses. The service catalog can be presented to the user through, for example, a web interface, or an interface on a dedicated management console 107, e.g., a graphical user interface or a command line interface.

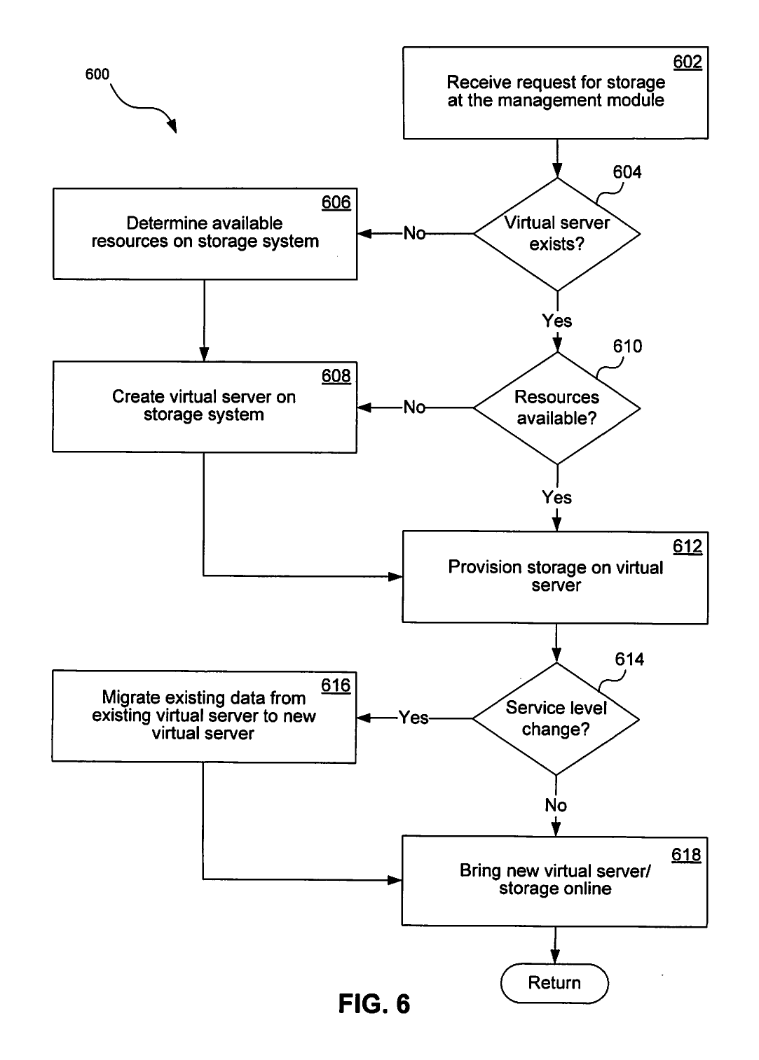

Upon receiving a request for storage from a customer, a management module 408 can automatically provision storage for the user based on the service level selected. The management module 408 can be implemented in special-purpose hardwired circuitry, programmable circuitry programmed by software and/or firmware, or in a combination thereof. As depicted in FIG. 4 the management module is connected to the cloud storage network 400 through the network 406; however, the management module could alternatively reside within the cloud storage network 400. The process of provisioning the storage from a user's request is described in more detail below with reference to FIG. 6.

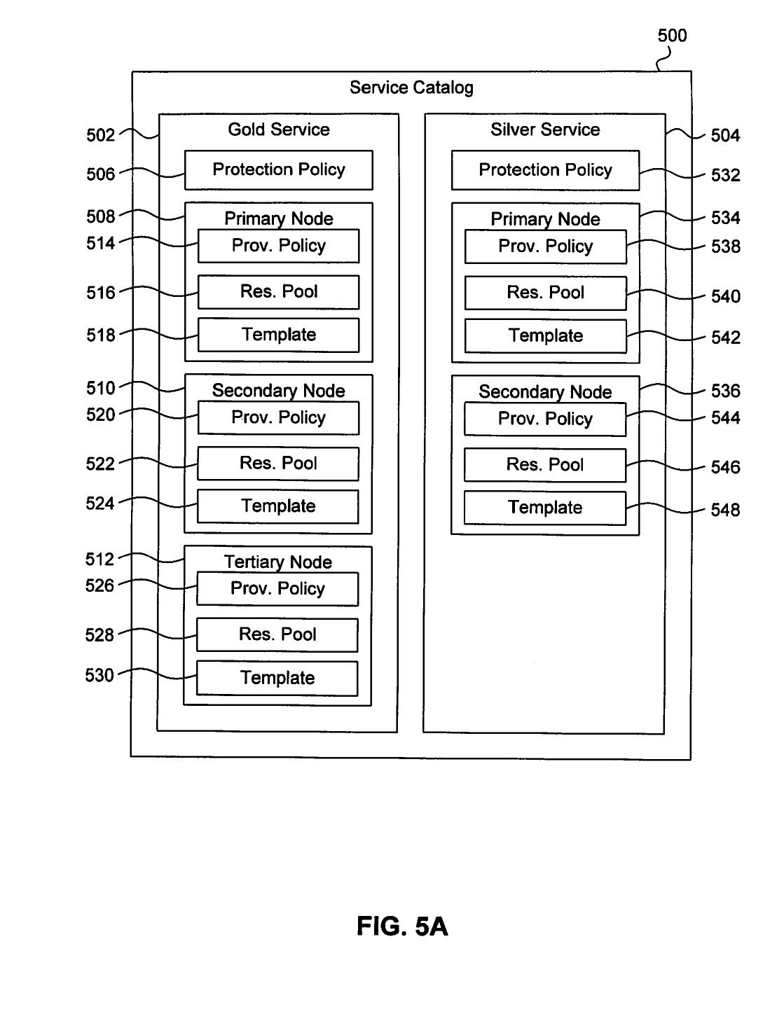

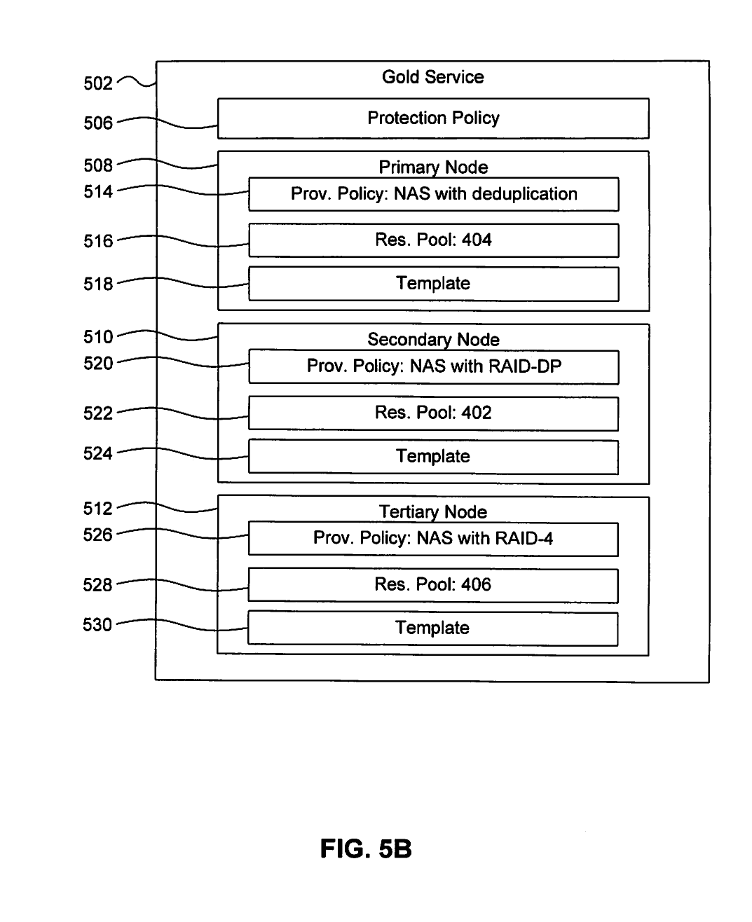

FIG. 5A shows conceptually an example of a service catalog 500. The example service catalog 500 of FIG. 5 includes two storage services, a gold service 502 and a silver service 504. One of ordinary skill in the art will recognize that a service catalog can include any number of storage services. The gold service 502 includes a protection policy 506 that defines a primary node 508, secondary node 510, and a tertiary node 512. The silver service 504 includes a protection policy 532 that defines a primary node 534 and a secondary node 536. In the exemplary services, each node 508, 510, 512, 534, and 536 is assigned a provisioning policy 514, 520, 526, 538, and 544, a resource pool 516, 522, 528, 540, and 546, and a virtual storage server template 518, 524, 530, 542, and 548, respectively. However, one or more of the elements shown in the exemplary services can be omitted and additional elements can be supplemented to meet system needs. For example, in one embodiment a service does not include a virtual server template and the information is simply provided by the administrator.

In one embodiment, the primary node in this exemplary context can be used by applications as primary storage, the secondary node can be used for backup storage, and the tertiary storage can be used for mirroring or other disaster recovery applications. Note that alternative embodiments of the node topology are envisioned, for example, the topology for a client application can include a primary storage node that is mirrored to two secondary nodes or a primary node mirrored to a secondary node as well as backed up to a tertiary node. Therefore, the example embodiment is not intended to limit the topology of the storage nodes.

FIG. 5B shows an example block diagram of the gold service 502 of FIG. 5A in more detail. The primary node 508 includes a provisioning policy 514 that defines a NAS environment that implements deduplication. The resource pool 514 for the primary node 508 is resource pool 404. The secondary node 510 includes a provisioning policy 520 that defines a NAS environment that implements RAID-DP. The resource pool 522 for the secondary node 510 is resource pool 402. The tertiary node 512 includes a provisioning policy 526 that defines a NAS environment that implements RAID-4. The resource pool 528 for the tertiary node 512 is resource pool 406. The virtual storage server template 518, 524, and 530 for primary node 508, secondary node 510, and tertiary node 512, respectively, each include a domain name system (DNS) domain name, a DNS server address, a network information service (NIS) domain name, an NIS server address, and CIFS settings, for example. Each virtual storage server template 518, 524, and 530 can be used by the management module 408 to create a virtual storage server for the node. The virtual storage server is created on a storage system 101 that is in the resource pool corresponding to the nodes defined in the service level.

FIG. 6 is a flow diagram of a process 600 for provisioning storage for a user in a multi-tenancy environment. It should be understood that at least some of the operations associated with this process can potentially be reordered, supplemented, or substituted for, while still performing the same overall technique.

The process 600 begins at 602 with the management module 408 receiving a request for storage. Many kinds of users can submit a request for storage and it should be apparent from the following examples that various combinations of information can be included in the request. In one embodiment, a user that does not currently use storage on the system can submit a request for storage on the cloud storage network, for example, using a web interface or a dedicated management console, for example, management station 107. In this case the request for storage can include, for example, a storage capacity and a service level. In another embodiment, a user who is already using storage on the cloud storage network can submit a request for storage to increase available storage capacity for a node on the cloud storage network. In this case, the storage request can include a storage capacity with no service level because storage associated with a service level already exists for that user. In yet another embodiment, a user can submit a request to change a service level, with or without a change in storage capacity.

At 604 the management module 408 determines whether a virtual storage server already exists in the cloud storage network 400 that is associated with the request for storage, e.g., has the same user and service level as those associated with the request. A virtual storage server can already exist in the cloud storage network 400, for example, when a user is requesting a change in the storage capacity. If a virtual storage server exists for a user but the user is requesting a service level change, the request can be treated as one with no virtual storage server existing and a new virtual storage server on a storage system meeting the new service level can be created. The data from the old virtual storage server can then be migrated to the newly created virtual storage server. This process is transparent to client applications that access the virtual server. If no virtual storage server associated with the user or the storage request already exists in the cloud storage network (604-No) the process continues to 606 where the management module 408 determines what resources are available that satisfy the service level included in the request for storage. Determining the resources available can include scanning a resource pool included in the service level and checking the storage systems in the storage pool for available storage capacity, provisioning requirements, e.g., RAID level, and the number of virtual storage servers currently on each storage system.

Once a suitable storage system has been found to host the virtual storage server, the management module 408 creates a virtual storage server on the storage system at 608. In an embodiment where the service level includes a virtual storage server template, the management module 408 creates the virtual storage server according to the parameters specified in the template. When creating a virtual storage server, several values must be specified. Many of the values are provided by the template. This means that the user request does not have to contain information it otherwise would have. If there is not a virtual storage server template included in the service level, a storage administrator can specify parameters, such as DNS, NIS, and CIFS settings, to create the virtual storage server. In one embodiment, the storage administrator obtains the proper DNS, NIS, and CIFS settings from the storage system that is to host the virtual storage server. Once a virtual storage server has been created, the management module 408 provisions storage at 612 according to the provisioning policy included in the service level.

Referring again to 604 where the management module determines whether a virtual storage server associated with the storage request, if a virtual storage server does exist (604-Yes) then the process continues to 610 where it is determined what resources are available to satisfy the storage request. Because a virtual storage server already exists on a storage system in the cloud storage network, determining available resources can include searching the current storage system to determine whether sufficient storage capacity is available. If there is sufficient storage capacity available on the storage system (610-Yes) the management module 408 provisions storage for the user at 612 according to the provisioning policy defined by the service level. In one embodiment, if sufficient storage capacity is not available on the storage system (610-No) the process continues to 608 where a new virtual storage server is created on a storage system that has sufficient storage capacity available and satisfies the service level requirements. The management module 408 links the newly created virtual storage server and the existing virtual storage server (if any) such that applications know that there are multiple virtual storage servers for future storage service requests.

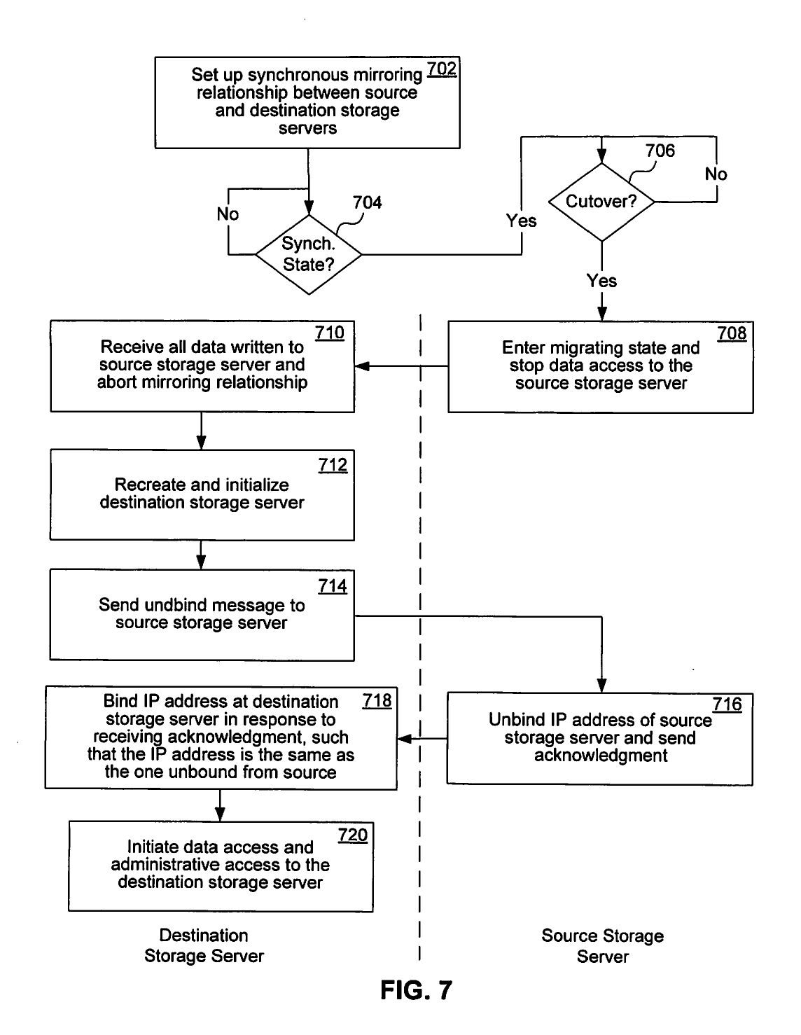

At 614 the management module 408 determines whether the request for storage includes a service level change. If the request includes a service level change (614-Yes) the process continues to 616 where, in one embodiment, the management module 408 migrates the existing data from the previous virtual storage server to the newly created virtual storage server such that applications continue to have access to data from the previous virtual server. In one embodiment, the migration process is performed such that any client applications accessing the virtual storage server are not disrupted. The migration process is described in more detail below with reference to FIG. 7. In another embodiment, some cases of a service level change may not require a migration of data. For example, when changes to data management implemented by the virtual server are made, e.g., snapshot frequency is adjusted or deduplication is turned on/off, the changes can be made without migrating the data to new storage.

At 618, the new virtual storage server is brought online and the user can begin to access data. If there is not a service level change, 614-No, then the newly created virtual storage server and/or the newly provisioned storage is brought online at 618 and the user can begin to access the storage. The process 600 can be repeated for each node defined by the protection policy of the selected service level.

FIG. 7 is a flow diagram of an example process for a non-disruptive storage server migration of 616 after a change in service level is requested. It should be understood that at least some of the operations associated with this process can potentially be reordered, supplemented, or substituted for while still performing the same overall technique.

In one embodiment, the migration process can be initiated by a user submitting a request to change service levels. For example, a user may want to change from silver service level 504 to gold service level 502. The source storage server of flowchart 700 is the existing virtual storage server currently used by client applications and, in this example, is located in resource pool 402. The destination storage server mentioned in flowchart 700 is the newly created virtual storage server to which the source storage server is to be migrated and, in this example, is located in the resource pool 404. The management module 408 sends a message to the source storage server and the destination storage server to start the migration.

At 702, a synchronous mirroring relationship is established between the source storage server and the destination storage server, such that data on the source storage server is copied to the destination storage server. While the source and destination storage servers are in the synchronous mirroring relationship, at 702, in response to any new data written to the source storage server (e.g., by a client application), a copy of the new data is written to the destination storage server. “New” data can include the modification of previously stored data. The synchronous mirroring relationship ensures that any configuration or data changes to the source storage server are reflected in the data on the destination storage server. While the storage servers are in the synchronous mirroring relationship, the source storage server remains in a running state (i.e., the source storage server operates as if no migration is taking place), such that client applications have data access to the source storage server, and the destination storage server remains in a migrating state (i.e., the destination storage server is being prepared for migration).

The process continues to 704 where the management module 408 determines whether the source storage server and the destination storage server have reached a synchronous state, i.e., the data on the volumes of the destination storage server is an accurate reflection of the data on the volumes of the source storage server. If the management module 408 determines that the storage servers are not in a synchronous state (704-No) then the mirroring process of 702 continues until the management module 408 determines that a synchronous state has been reached. Note that some data from the source storage server may be in transit to the destination storage server when the management module 408 determines that a synchronous state has been reached. A synchronous state, or where data contained on the destination storage server and the source storage server is substantially the same, in this case can be defined as a state such that all data written to the source storage server will be present on the destination storage server prior to completion of a cutover from the source storage server to the destination storage server.

When it is determined that a synchronous state has been reached (704-Yes) the process continues to 706 where the source storage server waits for an indication from the management module 408 for the cutover to take place. During this waiting period (706-No) the management module 408 determines whether the source storage server and the destination storage server are ready to complete the non-disruptive migration. The source and destination storage servers are ready to complete the non-disruptive migration when all running operations have been completed or aborted. The management module 408 issues a cutover command (706-Yes) when the management module determines that the source storage server and the destination storage server are ready for cutover and all running operations have been completed or aborted. At 708 the source storage server is put into a migrating state and data access by client applications is stopped. While data access and administrative access to the source storage server has been stopped at this point, the synchronous mirroring relationship between the source storage server and the destination storage server remains, such that all of the data written to the source storage server before access was stopped is reflected on the destination storage server.

At 710, after all of the data written to the source storage server prior to data access being stopped has reached the destination storage server, the synchronous mirroring relationship is aborted and no more data passes between the source storage server and the destination storage server. At 712 the source storage server configuration is recreated on the destination storage server (e.g., configuration of storage volumes, storage server sub-systems, etc.) such that the destination storage server would appear to the client applications to be the same storage server as the source storage server. The volumes copied from the source storage server during the mirroring process are brought online at the destination storage server. The configuration information included on the mirrored volumes is used to initialize the sub-systems of the destination storage server such that the sub-systems (e.g., NFS and SCSI) are in the same configuration as they were on the source storage server. Once the destination storage server has been recreated and initialized, at 714, the destination storage server sends a message to the source storage server to unbind the storage address (e.g., release the IP address) of the source storage server. To simplify description it is assumed throughout this example that the storage address is an IP address. However, other communication protocols and their related storage addresses are considered in this description.

At 716, in response to receiving the message from the destination storage server, the source storage server unbinds the IP address and sends an acknowledgment to the destination storage server. At 718 the destination storage server receives the acknowledgment from the source storage server and binds the IP address of the destination storage server (i.e., the IP address becomes active). The IP address at the destination storage server is now the same IP address that was unbound from the source storage server. Because of this continuity between the IP addresses, the client applications can begin to access data from the destination storage server without requiring reconfiguration of the client applications. At 720 the destination storage server is brought online and the client applications begin to access data from the destination storage server.

During the cutover period after the cutover command has been issued and data access has begun on the destination storage server, the client applications will not have access to either the source storage server or the destination storage server. This cutover period appears to the client applications only as an I/O pause in at least some usage scenarios. This temporary I/O pause can still be considered non-disruptive to the client applications because the client applications resume I/O access (from the destination storage server instead of the source storage server) without having to be restarted or reconfigured when the cutover is complete and thus the operation of the application is not interrupted. An interruption to the client application, as the term is used herein, is defined as timing out, restarting, reconfiguring, or any state which requires user input to correct. In a conventional migration, client applications must be shut down, restarted, and/or reconfigured prior to accessing data from the destination storage server. The protocol the client application uses to access data on the storage server determines how the client application reacts to this I/O pause. For example, a client application using an NFS or iSCSI protocol will keep retrying to access the source storage server until the destination storage server is brought online, at which point the destination storage server will service the client application.

The length of the cutover period is constrained by a protocol specified timeout period. For example, the NFS and iSCSI protocols typically have a timeout period of no longer than 120 seconds. If storage server access to the client application is not restored within this protocol specified timeout period, the client application will timeout and the migration can no longer be considered non-disruptive. Thus, it is important to know in advance the protocol timeout periods and to monitor the cutover process to determine whether a successful migration will complete within the protocol specified timeout period. If it is determined that a successful migration will not complete within the protocol specified timeout period, the migration can be aborted and client application data access resumed at the source storage server to insure that client applications are not disrupted. The migration can then be attempted later.

The techniques introduced above can be implemented by programmable circuitry programmed or configured by software and/or firmware, or they can be implemented by entirely by special-purpose “hardwired” circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware for implementing the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, can include, for example, special-purpose hardwired circuitry, software and/or firmware in conjunction with programmable circuitry, or a combination thereof.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

1. (canceled)

2. A method comprising:
in response to a request for a storage service level, determining that a first of a plurality of protection policies is associated with the storage service level, wherein the first protection policy indicates primary node information and secondary node information;
determining a first host from a first pool of hosts that has sufficient resources for the request, wherein the primary node information indicates the first pool of hosts in a cloud storage network;
creating a first virtual storage server on the first host;
provisioning storage for the first virtual storage server according to a first provisioning policy indicated in the primary node information;
determining a second host from a second pool of hosts that has sufficient resources for the request, wherein the secondary node information indicates the second pool of hosts in the cloud storage network;
creating a second virtual storage server on the second host;
provisioning storage for the second virtual storage server according to a second provisioning policy indicated in the secondary node information.

3. The method of claim 2, wherein the secondary node information describes a backup node or a mirroring node for a primary node described by the primary node information.

4. The method of claim 2, wherein the first pool of hosts conform to a first service level objective and the second pool of hosts conform to a second service level objective.

5. The method of claim 2, wherein creating the first virtual storage server comprises creating the first virtual storage server according to a template indicated in the primary node information.

6. The method of claim 2, wherein the first protection policy indicates at least one of a backup schedule, a mirroring schedule, data transfer control, backup retention control, and disaster recovery control.

7. The method of claim 2, wherein the first provisioning policy comprises at least one of storage area network provisioning specifications, network attached storage provisioning specifications, deduplication settings, space utilization thresholds, access protocol information, multi-tenancy access protocols, and a storage protection level.

8. The method of claim 2, wherein the request also indicates a requested storage capacity, wherein determining the first host has sufficient resources for the request comprises determining that the first host has sufficient storage capacity for the request.

9. The method of claim 2, further comprising:
in response to a second request from a requestor, determining that a third virtual storage server exists on a third host in the cloud storage network for the requestor;
determining that resources of the third host are insufficient for the request; and
accessing a second protection policy associated with the third virtual storage server determine a fourth host from a third pool of hosts that has sufficient resources for the second request, wherein the second protection policy comprises second primary node information which indicates the third pool of hosts in the cloud storage network;
creating a fourth virtual storage server on the fourth host;
provisioning storage for the fourth virtual storage server according to a third provisioning policy indicated in the second primary node information.

10. The method of claim 9 further comprising linking the fourth virtual storage server and the third virtual storage server to service requests for a dataset.

11. The method of claim 9 further comprising migrating a dataset of the third virtual storage server to the fourth virtual storage server.

12. One or more non-transitory machine-readable media comprising program code stored thereon, the program code to:
in response to a request for a storage service level, determine a first of a plurality of protection policies associated with the storage service level;
for each of a plurality of node levels indicated in the first protection policy,
determine a host from a pool of hosts that has sufficient resources for the request, wherein information about the node level indicates the pool of hosts in a cloud storage network;
create a virtual storage server on each determined host;
provision storage for each created virtual storage server according to a provisioning policy indicated in the information about the node level; and
bring the virtual storage servers online.

13. The non-transitory machine-readable media of claim 12, wherein a first node level of the plurality of node levels corresponds to a primary node and a second node level corresponds to a backup node or a mirroring node for a primary node described by the primary node information.

14. The non-transitory machine-readable media of claim 12, wherein each pool of hosts conforms to a different first service level objective.

15. The non-transitory machine-readable media of claim 12, wherein the program code to create the virtual storage server comprises program code to create the virtual storage server according to a template indicated in the information about the node level.

16. The non-transitory machine-readable media of claim 12, wherein the protection policy indicates at least one of a backup schedule, a mirroring schedule, data transfer control, backup retention control, and disaster recovery control.

17. An apparatus comprising:
a processor;
a machine readable storage medium with program code stored therein, the program code executable by the processor to cause the apparatus to,
in response to a request for a storage service level, determine a first of a plurality of protection policies associated with the storage service level;
for each of a plurality of node levels indicated in the first protection policy,
determine a host from a pool of hosts that has sufficient resources for the request, wherein information about the node level indicates the pool of hosts in a cloud storage network;
create a virtual storage server on each determined host;
provision storage for each created virtual storage server according to a provisioning policy indicated in the information about the node level; and
bring the virtual storage servers online.

18. The apparatus of claim 17, wherein a first node level of the plurality of node levels corresponds to a primary node and a second node level corresponds to a backup node or a mirroring node for a primary node described by the primary node information.

19. The apparatus of claim 17, wherein each pool of hosts conforms to a different first service level objective.

20. The apparatus of claim 17, wherein the program code to create the virtual storage server comprises program code executable by the processor to cause the apparatus to create the virtual storage server according to a template indicated in the information about the node level.

21. The apparatus of claim 17, wherein the protection policy indicates at least one of a backup schedule, a mirroring schedule, data transfer control, backup retention control, and disaster recovery control.
